(19) United States
(12) Patent Application Publication
(10) Pub. No.: US 2020/0019882 A1
(43) Pub. Date: Jan. 16, 2020

(54) Systems and Methods for Generating, Deploying, Discovering, and Managing Machine Learning Model Packages

(71) Applicant: Schlumberger Technology Corporation, Sugar Land, TX (US)

(72) Inventors: Sunil Garg, Katy, TX (US); Graziella Caputo, Houston, TX (US); Xinxin Kong, Sugar Land, TX (US); Daniel Gabriel D'Souza, Houston, TX (US)

(21) Appl. No.: 16/336,114

(22) PCT Filed: Dec. 15, 2016
(86) PCT No.: PCT/US2016/066783

§ 371 Date: Mar. 24, 2019

(51) Int. Cl. G06N 20/00

(52) U.S. Cl. CPC G06N 20/00

(57) ABSTRACT

Systems, computer-readable media, and methods are disclosed for generating machine learning model packages by training a machine leaning model, obtaining metadata corresponding to the model, generating a model execution script for executing the model, obtaining a re-training program associated with the model, where the re-training program can be used to re-train the model in a run-time environment of a target application, and generating a machine learning model package that includes the model, the metadata, the model execution script, and the re-training program. Systems, computer-readable media, and methods are also disclosed for deploying, discovering, and managing models by obtaining a machine learning model package, obtaining a model, metadata, and a model execution script from the machine learning model package, identifying inputs of the model based on the metadata, obtaining input data, and executing the model using the model execution script and the input data to analyze the input data.

### BACKGROUND

Workers in various organizations utilize and often rely on software systems to perform their work. For example, in the oil and gas industry, an exploration and production sector (E&P) software system allows users to interpret seismic data, perform well correlation, build reservoir models suitable for simulation, submit and visualize simulation results, calculate volumes, produce maps, and design development strategies to maximize reservoir exploitation.

Many industries have begun using machine learning techniques in software systems to perform various tasks without having to explicitly program a system to do so. For example, machine learning has been used in self-driving vehicles, speech recognition, and internet search engines.

In order to use machine learning algorithms, the algorithms build models by estimating the parameters of a machine learning algorithm using a known set of input/output data such that the prediction error is minimized, with a goal being that the resulting model is capable of generalizing and making predictions based on input data. Models can be validated by applying a trained model to an independent set of input/output data (not used in training) and verifying that the predicted output matches the actual known output with sufficiently high correlation.

Training and validation of machine learning models can be computationally expensive. Thus, in some instances, machine learning models can be built and trained using high performance computing devices that provide large amounts of distributed storage, memory, and processing resources. The trained and validated models can then be used by end-user devices that may not have the computational resources of a high performance device.

### SUMMARY

Systems, apparatus, computer-readable media, and methods are disclosed, of which the methods include training a machine learning model, obtaining metadata corresponding to the machine learning model, generating a model execution script for executing the machine learning model, obtaining a re-training program associated with the machine leaning model, where the re-training program can be used to re-train the machine learning model in a run-time environment of a target application, and generating a machine learning model package that includes the machine learning model, the metadata, the model execution script, and the re-training program.

In some embodiments, the methods can include encrypting a machine learning model file corresponding to the machine learning model, where the machine learning model in the machine learning model package is an encrypted version of the machine learning model file.

In further embodiments, the methods can include encrypting a metadata file that includes the metadata corresponding to the machine learning model, where the metadata in the machine learning model package is an encrypted version of the metadata file.

In other embodiments, the metadata file can correspond to a JavaScript Object Notation (JSON) schema.

In some implementations, the methods can include encrypting the model execution script, where the model execution script in the machine learning model package is an encrypted version of the model execution script.

In further implementations, the methods can include transmitting the machine learning model package to a client computer, where the model execution script is invoked by a target application or a data analytics wrapper on the client computer to execute the machine learning model.

In other implementations, the model execution script can obtain input from the target application or the data analytics wrapper, condition the input into a format that can be used by the machine learning model, input the input into the machine learning model, obtain output from the machine learning model, render the output into a format that can be read by the data analytics wrapper or the target application, and transmit the output to the data analytics wrapper or the target application.

In some embodiments, the metadata can include one or more of: a model identifier; a model name; a model description; a model type; a machine learning algorithm type; a model version; a model input; a model output; a model input type; a model output type; a pre-processing/conditioning program name; a post-processing program name; a time of model creation; a model execution script identifier; a re-training program name; a model author; or a modification time.

In further embodiments, the model execution script can include a user interface that is configured based on the metadata.

In other embodiments, the methods can include encrypting the re-training program, where the re-training program in the machine learning model package is an encrypted version of the re-training program.

Systems and apparatus are also disclosed that include a processor and a memory system with non-transitory, computer-readable media storing instructions that, when executed by the processor, causes the systems and apparatus to perform operations that include training a machine learning model, obtaining metadata corresponding to the machine learning model, generating a model execution script for executing the machine learning model, obtaining a re-training program associated with the machine leaning model, where the re-training program can be used to re-train the machine learning model in a run-time environment of a target application, and generating a machine learning model package that includes the machine learning model, the metadata, the model execution script, and the re-training program.

Non-transitory, computer-readable media are also disclosed that store instructions that, when executed by a processor of a computing system, cause the computing system to perform operations that include training a machine learning model, obtaining metadata corresponding to the machine learning model, generating a model execution script for executing the machine learning model, obtaining a re-training program associated with the machine leaning model, where the re-training program can be used to re-train the machine learning model in a run-time environment of a target application, and generating a machine learning model package that includes the machine learning model, the metadata, the model execution script, and the re-training program.

Systems, apparatus, computer-readable media, and methods are disclosed, of which the methods include obtaining a machine learning model package, obtaining a machine learning model, metadata, and a model execution script from the machine learning model package, identifying inputs of the machine learning model based on the metadata, obtaining input data, and executing the machine learning model using the model execution script and the input data to analyze the input data.

In some embodiments, obtaining the machine learning model, the metadata, and the model execution script can include decrypting an encrypted machine learning model file, an encrypted metadata file, and an encrypted model execution script from the machine learning model package.

In other embodiments, the metadata in a metadata file can correspond to the JavaScript Object Notation (JSON) schema.

In further embodiments, the methods can include mapping the inputs of the machine learning model with the input data based on the metadata.

In some implementations, the methods can include identifying a pre-processing program based on the metadata, and executing the pre-processing program on the input data to format the input data for use with the machine learning model.

In other implementations, the methods can include providing output of the machine learning model to a target application, where the input data is data from the target application or external spreadsheets.

In further implementations, the target application can be an exploration and production sector software system.

In some embodiments, the methods can include obtaining a re-training program.

In other embodiments, the methods can include obtaining local training data pairs, pre-processing local training data inputs from the local training data pairs, re-training the machine learning model using the local training data and the re-training program, and generating a new version of the machine learning model based on the re-training.

In further embodiments, the methods can include generating a new metadata file based on the re-training, and generating a new model execution script based on the re-training.

In still further embodiments, the methods can include scoring the machine learning model in a real-time system, and re-training the machine learning model using the re-training program based on a feedback loop from the real-time system.

In some implementations, the re-training can result in an updated version of the machine learning model, and the updated version can be obtained and deployed based on a notification that the updated version of the machine learning model is available.

In further implementations, obtaining the machine learning model package can include obtaining the machine learning model package via model discovery from a library of pre-trained models.

Systems and apparatus are also disclosed that include a processor and a memory system with non-transitory, computer-readable media storing instructions that, when executed by the processor, causes the systems and apparatus to perform operations that include obtaining a machine learning model package, obtaining a machine learning model, metadata, and a model execution script from the machine learning model package, identifying inputs of the machine learning model based on the metadata, obtaining input data, and executing the machine learning model using the model execution script and the input data to analyze the input data.

Non-transitory, computer-readable media are also disclosed that store instructions that, when executed by a processor of a computing system, cause the computing system to perform operations that include obtaining a machine learning model package, obtaining a machine learning model, metadata, and a model execution script from the machine learning model package, identifying inputs of the machine learning model based on the metadata, obtaining input data, and executing the machine learning model using the model execution script and the input data to analyze the input data.

The foregoing summary is intended merely to introduce a subset of the aspects of the present disclosure, and is not intended to be exhaustive or in any way identify any particular elements as being more relevant than any others. This summary, therefore, should not be considered limiting on the present disclosure or the appended claims.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates an example of a method for training a machine learning model, according to an embodiment.

FIG. 3 illustrates an example of generating a model execution script and a metadata file, according to an embodiment.

FIG. 4 illustrates an example of generating a machine learning model package, according to an embodiment.

FIG. 5 illustrates an example of decrypting a machine learning model package, according to an embodiment.

FIG. 6 illustrates an example of a method for preparing data for use in a machine learning model, according to an embodiment.

FIG. 7 illustrates an example of a method for using a machine learning model, according to an embodiment.

FIG. 8 illustrates an example of a method for re-training a machine learning model, according to an embodiment.

FIG. 9 illustrates a diagram of an example user interface that can be used for machine learning model execution and management, according to an embodiment.

FIG. 10 illustrates a diagram of an example user interface that can be used for machine learning model execution and management, according to an embodiment.

FIG. 11 illustrates a diagram of an example user interface that can be used for machine learning model execution and management, according to an embodiment.

FIG. 12 illustrates a diagram of an example user interface that can be used for machine learning model execution and management, according to an embodiment.

FIG. 13 illustrates an example of a model package generation, management, and deployment system, according to an embodiment.

FIG. 14 illustrates an example computing system that may execute methods of the present disclosure, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the disclosure. However, it will be apparent to one of ordinary skill in the art that certain embodiments of the disclosure may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are used to distinguish one element from another. For example, a first object or step could be termed a second object or step, and, similarly, a second object or step could be termed a first object or step, without departing from the scope of the disclosure. The first object or step, and the second object or step, are both, objects or steps, respectively, but they are not to be considered the same object or step.

The terminology used in the description herein is for the purpose of describing particular embodiments and is not intended to be limiting. As used in the description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

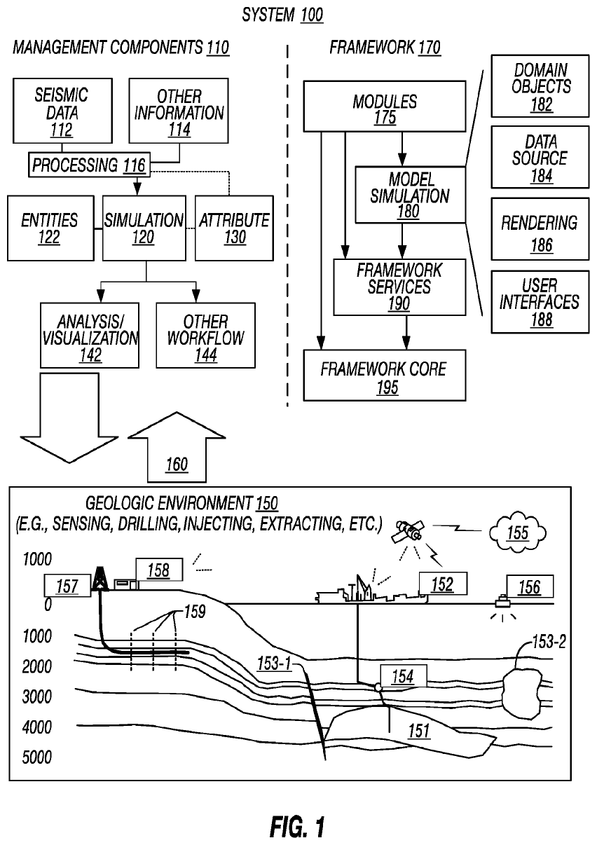

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142, and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET® framework (Redmond, Wash.), which provides a set of extensible object classes. In the .NET® framework, an object class encapsulates a module of reusable code and associated data structures. Object classes can be used to instantiate object instances for use by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (Schlumberger Limited, Houston Tex.), the INTERSECT™ reservoir simulator (Schlumberger Limited, Houston Tex.), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (Schlumberger Limited, Houston, Tex.). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (Schlumberger Limited, Houston, Tex.) allows for integration of add-ons (or plug-ins) into a PETREL® framework workflow. The OCEAN® framework environment leverages .NET® tools (Microsoft Corporation, Redmond, Wash.) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may also include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a workstep may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

In some embodiments, system 100 may include a system that can build, train, and/or validate machine learning models, build machine learning model packages, and/or deploy and distribute machine learning model packages. In further embodiments, such machine learning model packages can be used by a “target application” (e.g., an E&P software system). As used herein, a “target application” can represent any type of application, program, software system, environment, etc. that can utilize a machine learning model package, as described below.

In an E&P software system, the machine learning model packages can be used for faster and more efficient processes of, for example, automatically interpreting seismic data, interpreting geophysical data, interpreting reservoir data, performing well correlation, building reservoir models suitable for simulation, generating visualizations of simulation results, calculating volumes, producing maps, designing development strategies to maximize reservoir exploitation, forecasting production, predicting future events and hazards, and/or optimizing well plans.

As described herein, a machine learning model package can be a deployable package that includes a trained and validated machine learning model. In some embodiments, a machine learning model package can include a run-time compiled, trained, and validated machine learning model object that can be used to make predictions. For example, the model object can be an R programming language object, a Python programming language script or compiled program, a Matlab programming language executable package, etc. The deployable package can allow an end-user device (i.e., a client device) to use a machine learning model without having access to a model-building environment and/or a high-end computing device (e.g., a server).

In various embodiments, a machine learning model package can also include metadata that can be used to configure a user interface (“UI”) and/or a data analytics wrapper to use and/or run the model. As used herein, a data analytics wrapper can be a program executed on a client/server device that can be used to discover, retrieve, manage, validate, re-train, and/or to score a model, as described in further detail below. In some embodiments, a data analytics wrapper can be associated with, integrated with, and/or part of a target application (e.g., a plug-in application of the target application). In other embodiments, a data analytics wrapper can be independent of a target application. Additionally, a data analytics wrapper can be used to provide a UI for a user to access, utilize, visualize and/or analyze the input/output data and/or metadata for the models.

The metadata included in a machine learning model package can be used to improve accessibility, usability, re-usability, and compatibility of a model, and, thus, improve the overall efficiency of a model. For example, metadata that indicates a model type or description of a model can be used to improve accessibility of a model by allowing for the model to be identified during a search of model types. As an additional example, metadata that indicates inputs or outputs of a model can be used to improve usability of a model by facilitating identification of an appropriate model to achieve a desired output using a given input. As a further example, metadata that indicates input or output types can be used to improve compatibility of a model by facilitating identification of models that are compatible with formats of other processes (e.g., of a target application, of a data analytics wrapper, of a model execution script, etc.).

Accordingly, part of a machine learning model packaging process can be to generate descriptive metadata of a machine learning model. The metadata can allow a model execution script, data analytics wrapper, and/or a target application to identify a model and invoke the trained model object. Metadata fields can include, but are not limited to:

Model identifier (ID): a unique identifier of a model, which can, in some embodiments, can be unique across the models deployed in a target application or in a model server eco-system.

Model name: a free form name that can also be used as a quick indicator of what the model does and/or can be used in a visualization of the model in a UI to identify a model to a user.

Description: a longer description of the purpose and/or functions of a model.

Model program name: a name of a program that executes a model (e.g., within and/or associated with a target application).

Model type: an identifier of an engine responsible for interpreting the machine learning model and/or scoring the model (e.g., an R engine, a Python engine, a Matlab engine, etc.).

Machine learning algorithm type: an identifier that can indicate whether the training of the algorithm is supervised or unsupervised.

Version number: an indicator of the version of the model, which can allow multiple versions to be available for use (e.g., for compatibility purposes), identify if a stored version of a model is a current version, define a lineage to a parent version from which a re-trained version is generated, etc. A version number may be generated automatically or can be user defined.

Inputs: a user-readable or target-application-readable description of inputs to the model.

Outputs: a user-readable or target-application-readable description of outputs from the model.

Input type: an indicator of a type of the input object(s) (e.g., 2-Dimensional surface or a 3-Dimensional cube).

Output type: an indicator of a type of the output object(s).

Pre-processing/conditioning program name: an indicator of a program that can be invoked sequentially or in parallel to condition the input data before it is passed to the model.

Post-processing program name: an indicator of a program that can be invoked sequentially or in parallel to process the output data to render it into a format that the target application can use.

Time of creation: an indicator of a date and time at which the model was built and/or trained.

Model execution script: an identifier of the model execution script associated with the model.

Re-training program: a name of a program that re-trains the model.

Model author: a name(s) of the author(s) of the model.

Modification time: an indicator of a date and time at which the model was last modified.

In various embodiments, the metadata can be extensible to allow new elements to be easily and rapidly added. For example, the metadata can be formatted based on a machine-readable schema (e.g., the JavaScript Object Notation (“JSON”) schema), that can inherit from another, base schema. This can allow the current schema to define additional attributes, constrain existing attributes, or add other constraints from the base schema.

In other embodiments, a machine learning model package can include a re-training program to re-train a model in a run-time environment of the target application, which may not have access to the model building and/or training environment.

In further embodiments, a machine learning model package can include a model execution script that can execute the trained model object. For example, the model execution script can be configured to receive input data, execute the model with the input data, and transmit output data to a post-processing program, the data analytics wrapper, or the target application. In some embodiments, the model execution script can include a UI that is configured based on metadata associated with a model. In other embodiments, the machine learning model package can also include a re-training program, as discussed in further detail below.

In some implementations, a machine learning model package can include a data pre-processing/conditioning program that can be used to condition the input data before it is passed to the model. The data pre-processing/conditioning program can, in some embodiments, be the same or similar to a program used to condition or build the model, so that similar data conditioning can be performed in the target application environment before the model is executed. In various embodiments, the data pre-processing/conditioning program can be invoked sequentially or in parallel to condition the input for the model.

In other implementations, a machine learning model package can include a data post-processing program that can be used to format the output data for a target application. In various embodiments, the data post-processing program can be invoked sequentially or in parallel to format the output for the target application.

In further implementations, pre and post-processing programs can be used by multiple models.

In various embodiments, a machine learning model package can include functionality to deploy machine learning libraries and/or packages that are used by various models, program languages, or environments that the models are associated with (e.g., R, Python, Matlab, Machine Learning Library (MLlib), etc.). For example, a machine learning model implemented using the MLlib distributed machine learning framework can be packaged with libraries and packages of the MLlib framework and executable instructions (e.g., a program or script) that deploy the libraries and packages, allowing the MLlib model to operate.

In some embodiments, a machine learning model package can be secured using, for example, code compilation, obfuscation, signing, public/private key encryption, etc. Thus, the machine leaning model package can be secured against misuse and/or hacking.

In further embodiments, system 100, as shown in FIG. 1, may include a system that can search for and/or discover and obtain machine learning model packages, decrypt models, metadata, and model execution scripts from the machine learning model packages, re-train models, use the models with data from a target application, obtain output of the models, and/or use the output in a target application. In further embodiments, the system can also provide a UI for facilitating quality control of the models, displaying metadata associated with the models, applying filters to data, and displaying the output to a user.

In some embodiments, the system can include a data analytics wrapper. In further embodiments, the data analytics wrapper can be re-usable. In other words, the data analytics wrapper may not be limited to deploying one machine learning model, but can be used for to deploy multiple machine learning models. For example, a data analytics wrapper associated with an E&P software system may be used to retrieve and deploy a first machine learning model package with a model programmed in the Python programming language and the same data analytics wrapper may be used to retrieve and deploy a second machine learning model package with a model programmed in the R programming language. In other embodiments, a data analytics wrapper associated with an E&P software system may be used to retrieve and deploy a first machine learning model package with a first version of a model and the same data analytics wrapper may be used to retrieve and deploy a second machine learning model package with an updated version of the model. Thus, a data analytics wrapper can be configured to retrieve, deploy, and/or interface with one or more machine learning model packages (e.g., via a model execution script) and/or programming languages.

In some implementations, a data analytics wrapper can include an executable UI that can be dynamically configured based on metadata of a model included in a machine learning model package. Thus, even if the target application does not have a native UI for displaying information associated with a machine learning model, the target application can use the model metadata and the data analytics wrapper to allow the target application and/or a user to invoke the model as part of a native application workflow of the target application.

In other implementations, a data analytics wrapper can be configured to interface with and/or read data from a target application. Thus, the data analytics wrapper can allow data to be passed from the target application to the model (e.g., via a model execution script), allowing the data from the target application to be analyzed using the model.

In some embodiments, a data analytics wrapper may be able to read data from the target application and then invoke a data pre-processing/conditioning program to condition the data read from the target application. Then, the data analytics wrapper can invoke the model (e.g., via a model execution script) with the conditioned data, and the model can process and/or analyze the conditioned data. In further embodiments, the input data can be read from sources outside of the target application (e.g., external spreadsheets).

In some implementations, a data analytics wrapper can be configured to interface with and/or retrieve data output from the model (e.g., via a model execution script). For example, the retrieved data output from the model can be predicted or categorized output. In some embodiments, the data can be retrieved after processing the data using a data post-processing program that formats the output data (e.g., for a target application). In other embodiments, the data analytics wrapper can generate a visualization of the data output using, for example, a UI associated with the data analytics wrapper or the model execution script or can interface with the target application to generate a visualization using a UI of the target application. In further embodiments, the data analytics wrapper can store the retrieved data output in memory so that the retrieved data persists after model execution is complete.

In other implementations, a data analytics wrapper can be configured to deploy models in various deployment environments, including, for example: different operating systems (e.g., Linux Windows®, Android®, iOS®, etc.); different deployment platforms (e.g., desktops, servers, mobile devices, etc.); different frameworks and/or programming languages (e.g., Java®, .NET®, Scala®, etc.); etc. Additionally, a data analytics wrapper can be configured for local in-application deployment (e.g., a model is stored locally and is accessible using the data analytics wrapper in the target application) and/or remote cluster/cloud deployment (e.g., model is stored remotely and is invoked remotely using the data analytics wrapper). Thus, a data analytics wrapper may be reusable across multiple products, platforms, run-time environments, etc.

In various embodiments, a data analytics wrapper can be configured to search for and discover models that are deployed locally in a target application and/or models that are deployed in a remote cluster/cloud environment. For example, discoverable paths (e.g., a path on a local disk, a Uniform Resource Identifier (URI), a Uniform Resource Locator (URL), etc.) can be configured using model metadata and/or environment variables.

In some embodiments, a data analytics wrapper can be configured to validate and/or perform quality control on a model. For example, the data analytics wrapper can validate a model by running a known set of input/output data and calculating the correlation of the predicted outputs with the known outputs. The target application can then display the calculated correlations using a correlation coefficient or another such measure and/or a visualization tool (e.g., a cross-plot, a correlation matrix, etc.).

In other embodiments, a model can be re-trained using local data and/or data provided by a user and a re-training program. For example, a re-training of a model can be triggered by a determination that a correlation of predicted outputs with known outputs, based on validating the model, is below a pre-determined threshold. The re-training process can recalculate the parameters of the model based on the re-training data and then produce a new, re-trained version of the model. Thus, a model can be re-trained based on local data or user-provided data to provide more accurate output for a local target application/user. Additionally, in some embodiments, the data analytics wrapper can maintain copies of the original model (e.g., to maintain lineage of the model, allow for reversion to the original, etc.) and the re-trained model. Further, in various embodiments, re-training can be performed locally, on a model server, in a cloud computing environment, or a Hadoop cluster.

In further embodiments, a data analytics wrapper can be configured to score models. In some implementations, a model can be scored in a local application environment, while, in further implementations, a model can be scored in a remote cluster/cloud environment. As an example, a model can be scored by: running the model against a remote dataset and viewing results of the scoring in an application hosted remotely with the dataset; pushing the data to a remote environment for model scoring and receiving results at a local application; and/or automatically downloading the model from a remote environment and scoring the model locally.

In some embodiments, a data analytics wrapper can manage model versions. Model versions can be associated with a model version number. A model version number can be a numerical value, a textual identifier, etc. An updated model version may contain the same machine learning algorithm with different values for the parameters. If the machine learning algorithm is changed, the result is a new model, not a new version of a model.

In some implementations, a first version of a model can be deployed on an end-user device, and the model may be remotely re-trained (e.g., using a remote high-performance device/server) using global data. In further implementations, models can be trained and re-trained based on a feedback loop from real-time systems that are scoring the models. The re-training may result in an updated second version of the model. In other implementations, the data analytics wrapper can notify a user when an updated version of the model is available, and/or obtain and deploy the updated version (e.g., automatically).

In further implementations, new versions can be tested (e.g., remotely at a high-performance device/server, locally by a data analytics wrapper, etc.) to determine if the new version of the model out performs an older version(s) (e.g., predicts better). For example, known sets of input/output data can be processed through the model and the performance can be compared to previous versions. Model performance can also be determined based on, for example, processing speed, storage size, etc. In various implementations, if a new version of a model outperforms a previous version that is currently deployed on a device, a data analytics wrapper may automatically deploy the new version. In other implementations, the data analytics wrapper may determine whether to deploy the new version based on, for example, user preferences/polices and/or user input.

In further embodiments, a data analytics wrapper can group deployed models on an end-user device or on one or more model servers. For example, multiple models for different regions that solve a particular set of problems can be grouped together. Additionally, models may be grouped based on the outputs of the models (e.g., production potential, drilling non-productive time, etc.). The grouped models can provide a library of pre-trained models for different regions, different outputs, and/or using different machine learning algorithms. The library can facilitate model discovery by an end-user for specific tasks, regions, target applications, products, platforms, run-time environments, etc.

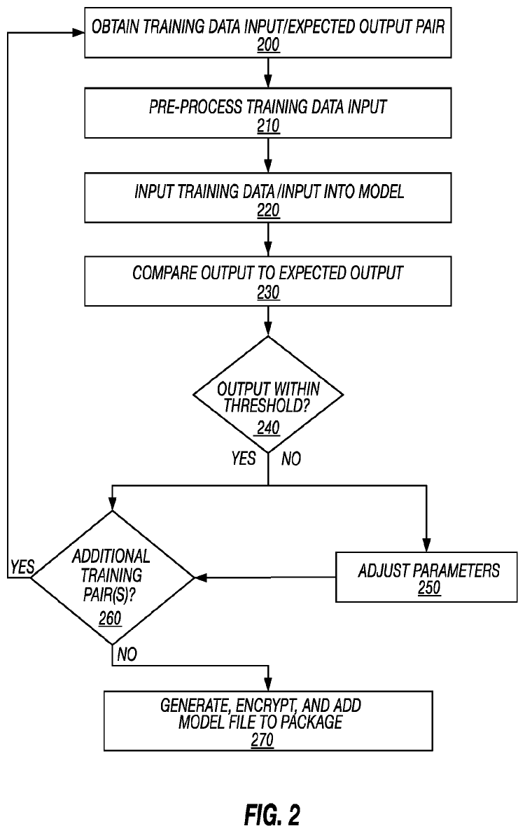

FIG. 2 illustrates an example of a method for training a machine learning model, according to an embodiment. The method shown in FIG. 2 is merely a simplified example of a supervised method of training a machine learning model. In further embodiments, training methods can include additional or fewer processes, perform processes in different orders, perform two or more processes in parallel, etc. Additionally, other methods (e.g., unsupervised methods) can be used to train machine learning models, as known in the art.

In various embodiments, a machine learning model can be used to automate data analysis and interpretation, reservoir simulation, map generation, etc., in an E&P software system, Thus, the training data can be used in various processes to, for example, maximize reservoir exploitation. In some embodiments, the example method illustrated in FIG. 2 can be performed using a computing device that includes the framework (e.g., framework 170) and the management components (e.g., management components 110) described above with reference to FIG. 1. In further embodiments, the example method illustrated in FIG. 2 can be performed on high-end servers that provide large amounts of distributed storage, memory, and processing resources (e.g., in comparison to a client device). In still further embodiments, the example method can be performed using computing devices in a cloud computing environment or a distributed computing Hadoop cluster.

The example method can begin in 200 when the computing device obtains a training data input and expected output pair to be used to train a machine learning model. In some embodiments, the training data can be received from a remote device (e.g., a remote database), while, in other embodiments, the training data can be obtained from local storage on the computing device.

In various embodiments, the training data can be reservoir data such as, for example, seismic data, geophysical data, well data (e.g., production data, drilling data, well logs, and markers), models, visualizations, simulations, maps, images, videos, charts, graphs, etc. that correspond to one or more reservoirs.

In some embodiments, the training data may include measured properties of a reservoir determined using, for example, core samples, seismic analysis, nuclear magnetic resonance, gamma ray logging, any other type of well logging, etc. Such properties can be collected using devices such as well-logging tools, logging-while-drilling devices, seismic receivers (e.g., geophones), imaging devices, etc. Measured properties can include, for example, rock type, porosity, permeability, pore volume, volumetric flow rates, well pressure, gas/oil ratio, composition of fluid in the reservoir, etc.

In further embodiments, the training data can also include analysis data. The analysis data can represent the result of an analysis of the data by an interpreter, by a machine learning process, etc. For example, a well log can include analysis data from an interpreter that identifies types of geological material associated with the data.

In 210, the computing device can pre-process the training data input. In some embodiments, the pre-processing can include converting the training data input into a format that can be read by the machine learning model.

In 220, the computing device can input the training data input into the machine learning model, and the machine learning model can analyze the training data input and produce an analysis output (e.g., a classification of the training data input). For example, the computing device can input well data into the machine learning model, and the machine learning model can analyze the well data and produce a predicted type of geological material associated with the well data

In 230, the computing device can compare the output of the machine learning model to the training data expected output. For example, the computing device can compare a type of geological material predicted based on well data input into the machine learning model to analysis data that indicates a type of geological material shown in the well data.

In some embodiments, the computing device can utilize a distance function to determine a distance between the output of the machine learning model and the training data expected output.

In 240, the computing device can determine if the output is within a pre-determined threshold of the expected output or otherwise corresponds to the expected output. For example, the computing device can determine if a type of geological material predicted based on well data input into the machine learning model is the same as a type of geological material shown in analysis data of the well data.

In some embodiments, the computing device can determine if a distance between the output and the expected output is less than or equal to the threshold.

If, in 240, the output is within the threshold, the process can proceed to 260. The output being within the threshold can represent, in some instances, that the computed machine learning model is properly configured to analyze the training data input (within a degree of prediction error). If, in 240, the output is not within the threshold, the process can proceed to 250.

In 250, the computing device can adjust parameters of the machine learning model. In some embodiments, the parameters can be adjusted based on the distance between the output and the expected output. Then, the process can proceed to 260.

In 260, the computing device can determine whether there are additional training pairs to use to train the machine learning model. If, in 260, there are additional training pairs, the process can return to 200 and the computing device can perform 200-260 for each additional training pair.

If, in 260, there are no additional training pairs, the process can proceed to 270 and the computing device can generate a machine learning model file (e.g., one or more files executable by a model execution script), the computing device can encrypt the file (e.g., using code compilation, obfuscation, signing, public/private key encryption, etc.), and the computing device can add the encrypted model file to a machine learning model package.

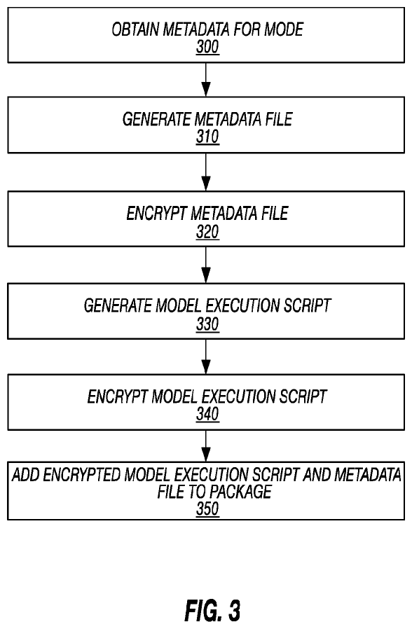

FIG. 3 illustrates an example of generating a model execution script and a metadata file, according to an embodiment. The method shown in FIG. 3 is merely a simplified example. In further embodiments, script and/or file generation methods can include additional or fewer processes, perform processes in different orders, perform two or more processes in parallel, etc.

In some embodiments, the example method illustrated in FIG. 3 can be performed using a computing device that includes the framework (e.g., framework 170) and the management components (e.g., management components 110) described above with reference to FIG. 1. In further embodiments, the example method illustrated in FIG. 3 can be performed on one or more servers that can also be used to train and validate machine learning models. In still further embodiments, the example method can be performed using computing devices in a cloud computing environment or a distributed computing Hadoop cluster.

The process can begin in 300, when the computing device obtains metadata for a model. In various embodiments, the metadata can be generated manually. In further embodiments, the metadata can be generated automatically based on determined inputs/outputs of the model, file names associated with the model, code associated with the model, etc. In other embodiments, the metadata can be received or retrieved from storage (e.g., from a database).

In 310, in some embodiments, the computing device can generate a metadata file based on the metadata obtained in 300. For example, the computing device can generate a JSON format metadata file based on the obtained metadata. In further embodiments, the metadata obtained in 300 may already be in the form of a metadata file. Accordingly, in some implementations, the computing device may not generate a new file, but can use the file that is obtained in 300. In further implementations, the computing device can convert the file that is obtained into a new file type (e.g., into a JSON format metadata file).

In 320, the computing device can encrypt the metadata file (e.g., using code compilation, obfuscation, signing, public/private key encryption, etc.).

In 330, the computing device can generate a model execution script. In some embodiments, a model execution script can be an executable program that can be invoked by a target application or a data analytics wrapper to execute a machine learning model by obtaining input from the target application or data analytics wrapper, conditioning the input into a format that can be used by the model, inputting the input into the model, obtaining output from the model, rendering the output into a format that can be read by the data analytics wrapper or the target application, and/or transmitting the output to the data analytics wrapper or the target application.

In 340, the computing device can encrypt the model execution script (e.g., using code compilation, obfuscation, signing, public/private key encryption, etc.).

In 350, the computing device can add the encrypted metadata file and the encrypted model execution script to a machine learning model package. In further embodiments, the computing device can also add a re-training program (e.g., an encrypted re-training program), that can be used to re-train a machine learning model, to the machine learning model package.

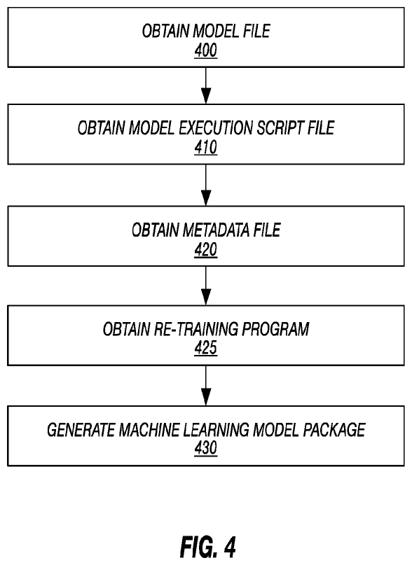

FIG. 4 illustrates an example of generating a machine learning model package, according to an embodiment. The method shown in FIG. 4 is merely a simplified example. In further embodiments, package generation methods can include additional or fewer processes, perform processes in different orders, perform two or more processes in parallel, etc.

In some embodiments, the example method illustrated in FIG. 4 can be performed using a computing device that includes the framework (e.g., framework 170) and the management components (e.g., management components 110) described above with reference to FIG. 1. In further embodiments, the example method illustrated in FIG. 4 can be performed on one or more servers that can also be used to train and validate machine learning models. In still further embodiments, the example method can be performed using computing devices in a cloud computing environment or a distributed computing Hadoop cluster.

The process can start in 400, when the computing device obtains a model file. For example, the computing device can obtain a model file by generating and encrypting the model file as described above with regard to 270 in FIG. 2.

In 410, the computing device can obtain a metadata file. For example, the computing device can obtain a metadata file by generating and encrypting the metadata file as described above with regard to 310 and 320 in FIG. 3.

In 420, the computing device can obtain a model execution script. For example, the computing device can obtain a model execution script by generating and encrypting the model execution script as described above with regard to 330 and 340 in FIG. 3.

In 425, the computing device can obtain a re-training program that can be used to re-train the machine learning model associated with the model file obtained in 400. The re-training program can be configured to re-train the model in a run-time environment of a target application.

In 430, the computing device can generate a machine learning model package. In some embodiments, the computing device can generate the package by adding, compressing, packaging, and/or encrypting a model file, a metadata file, a model execution script, and a re-training program associated with one machine learning model. For example, the model file, the metadata file, the model execution script, and the re-training program can be compressed into a single deployable file. In other embodiments, 430 can represent a combination of the processes described in 270 in FIGS. 2 and 350 in FIG. 3.

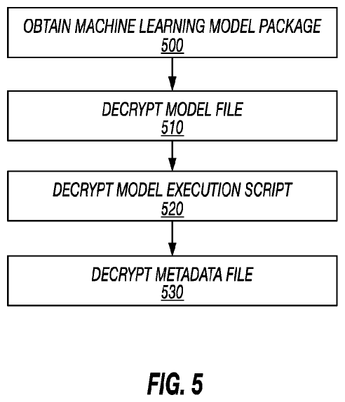

FIG. 5 illustrates an example of decrypting a machine learning model package, according to an embodiment. The method shown in FIG. 5 is merely a simplified example. In further embodiments, package decryption methods can include additional or fewer processes, perform processes in different orders, perform two or more processes in parallel, etc.

In some embodiments, the example method illustrated in FIG. 5 can be performed using a computing device that includes the framework (e.g., framework 170) and the management components (e.g., management components 110) described above with reference to FIG. 1. In further embodiments, the example method illustrated in FIG. 5 can be performed on one or more client devices that can also run or otherwise invoke a target application or on one or more model servers. In still further embodiments, the example method can be performed using computing devices in a cloud computing environment or a distributed computing Hadoop cluster. In other embodiments, the example method illustrated in FIG. 5 can be performed using a data analytics wrapper that is associated with the target application (e.g., is a plug-in application of the target application).

The process can start in 500, when the computing device obtains a machine learning model package. In some embodiments, the computing device can retrieve a machine learning model package from a server that can train and validate machine learning models and/or generate machine learning model packages. In some embodiments, the machine learning model package may be a newly retrieved machine learning model package. The machine learning model package may be retrieved based on, for example, instructions from a user, a determination that the machine learning model input and/or output corresponds to an active workflow in a target application, etc. In other embodiments, the machine learning model package may be an updated machine learning model package that includes a new version of a machine learning model that was further trained at a server. For example, the machine learning model may be periodically or continuously trained at a server.

In various embodiments, the machine learning model package may be a file that includes a model file, a metadata file, and a model execution script associated with one machine learning model. For example, the machine learning model package can be generated using the process described above in FIG. 4.

In 510, the computing device can decrypt the machine learning model in the machine learning model package. In some embodiments, the model file may be secured using code compilation, obfuscation, signing, public/private key encryption, etc. Thus, the computing device can decrypt the machine learning model using a password, a private key, etc.

In 520, the computing device can decrypt the model execution script that can execute the machine learning model from the machine learning model package. In some embodiments, the computing device can decrypt the model execution script by removing, decompressing, and/or un-packaging the model execution script file that is included in the machine learning model package. In further embodiments, the model execution script may be secured using code compilation, obfuscation, signing, public/private key encryption, etc. Thus, the computing device can decrypt the model execution script using a password, a private key, etc.

In 530, the computing device can decrypt the metadata file that includes metadata associated with the machine learning mode from the machine learning model package. In some embodiments, the computing device can decrypt the metadata file by removing, decompressing, and/or un-packaging the metadata file that is included in the machine learning model package. In further embodiments, the metadata file may be secured using code compilation, obfuscation, signing, public/private key encryption, etc. Thus, the computing device can decrypt the metadata file using a password, a private key, etc.

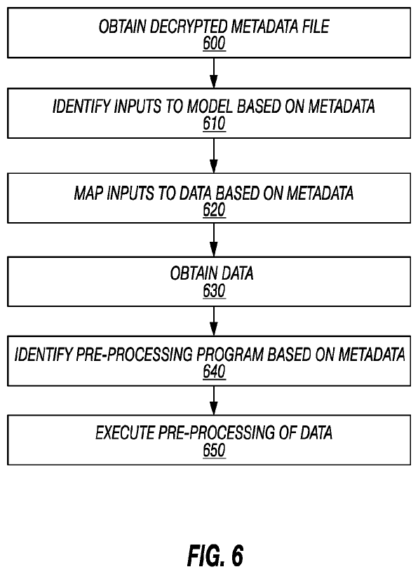

FIG. 6 illustrates an example of a method for preparing data for use in a machine learning model, according to an embodiment. The method shown in FIG. 6 is merely a simplified example. In further embodiments, data preparation methods can include additional or fewer processes, perform processes in different orders, perform two or more processes in parallel, etc.

In some embodiments, the example method illustrated in FIG. 6 can be performed using a computing device that includes the framework (e.g., framework 170) and the management components (e.g., management components 110) described above with reference to FIG. 1. In further embodiments, the example method illustrated in FIG. 6 can be performed on one or more client devices that can also run a target application. In still further embodiments, the example method can be performed using computing devices in a cloud computing environment or a distributed computing Hadoop cluster. In other embodiments, the example method illustrated in FIG. 6 can be performed using a data analytics wrapper that is associated with the target application (e.g., is a plug-in application of the target application).

The example method can begin in 600 when the computing device obtains a decrypted metadata file associated with a machine learning model. In some embodiments, the metadata file can be decrypted from a machine learning model package that also includes the machine learning model and can be decrypted by the computing device, as described with regard to 530 in FIG. 5, above.

In various embodiments, the metadata file can include metadata that identifies inputs of the model and formats that correspond to the inputs of the model.

Accordingly, in 610, the computing device can open the metadata file (e.g., a metadata file that corresponds to the JSON schema) and identify the inputs to the model by analyzing the metadata in the metadata file. For example, the metadata can indicate that the model accepts a well log as an input and specifies a format and/or file type of the well log.

In 620, the computing device can, based on the metadata, map inputs of the model to data from a database and/or from the target application. For example, the computing device can map a well log output of a process performed by the target application to a well log input of the model.

In 630, the computing device can obtain data to feed into the model based on the mapping in 620. In some embodiments, the data can be obtained from the target application and/or data obtained from a database associated with the target application based on the mapping in 620.

In various embodiments, the data can be reservoir data such as, for example, seismic data, geophysical data, well data (e.g., production data, drilling data, well logs, and markers), models, visualizations, simulations, maps, images, videos, charts, graphs, etc. that correspond to one or more reservoirs.

In some embodiments, the data may include measured properties of a reservoir determined using, for example, core samples, seismic analysis, nuclear magnetic resonance, gamma ray logging, any other type of well logging, etc. Such properties can be collected using devices such as well-logging tools, logging-while-drilling devices, seismic receivers (e.g., geophones), imaging devices, etc. Measured properties can include, for example, rock type, porosity, permeability, pore volume, volumetric flow rates, well pressure, gas/oil ratio, composition of fluid in the reservoir, etc.

For example, the data can be well data in the form of well logs that are mapped from a workflow and/or displayed on the target application.

In 640, the computing device can identify a pre-processing program associated with the model based on the metadata. In some embodiments, the metadata can include a pre-processing program name, which can be an indicator of a program that can be invoked sequentially or in parallel to condition the input data before it is passed to the model. Accordingly, the computing device can access and/or obtain the pre-processing program based on identifying the program in the metadata.

In 650, the computing device can execute pre-processing of the data using the pre-processing program. For example, the computing device can pre-process well data into a format that can be input into the model. In some embodiments, if the data is already in a format that is acceptable by the model, then the pre-processing may not be performed and the “pre-processed data” can be the same as the original data.

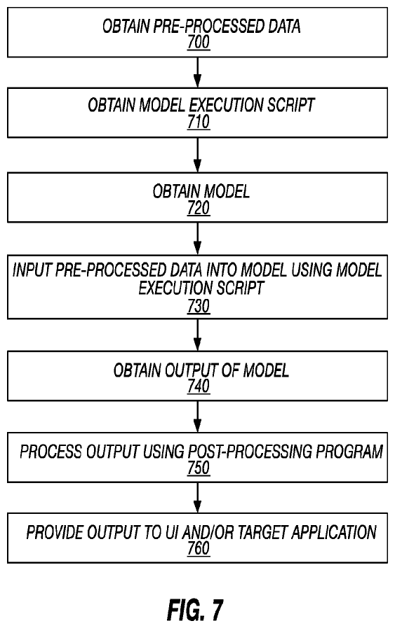

FIG. 7 illustrates an example of a method for using a machine learning model, according to an embodiment. The method shown in FIG. 7 is merely a simplified example. In further embodiments, model usage methods can include additional or fewer processes, perform processes in different orders, perform two or more processes in parallel, etc.

In some embodiments, the example method illustrated in FIG. 7 can be performed using a computing device that includes the framework (e.g., framework 170) and the management components (e.g., management components 110) described above with reference to FIG. 1. In further embodiments, the example method illustrated in FIG. 7 can be performed on one or more client devices that can also run a target application. In still further embodiments, the example method can be performed using computing devices in a cloud computing environment or a distributed computing Hadoop cluster. In other embodiments, the example method illustrated in FIG. 7 can be performed using a data analytics wrapper that is associated with the target application (e.g., is a plug-in application of the target application).

The example method can begin in 700 when the computing device obtains pre-processed data for feeding to a machine learning model. For example, the pre-processed data can be obtained by executing pre-processing of data, as described above with regard to 650 in FIG. 6.

In 710, the computing device can obtain a decrypted model execution script associated with the machine learning model. In some embodiments, the model execution script can be decrypted from a machine learning model package that also includes the machine learning model and can be decrypted by the computing device, as described with regard to 520 in FIG. 5, above.

In 720, the computing device can obtain the decrypted machine learning model. In some embodiments, the machine learning model can be decrypted by the computing device, as described with regard to 510 in FIG. 5, above.

In 730, the computing device can execute the model execution script to input the pre-processed data into the model and execute the model with the pre-processed data. For example, the model execution script can input pre-processed well data into the model and execute the model with the well data.

In 740, the computing device can obtain output of the model as a result of the model execution. In some embodiments, the output of the model can be an analysis and/or classification of the data. For example, if the data input into the model is well data, the output of the model can include indications of predicted types of geological material associated with the well data.

In 750, the computing device can process the output using a post-processing program that formats the output data (e.g., for a target application).

In 760, the computing device can provide the output of the model to a user interface for display to a user and/or to a target application that can display the output and/or use the output as part of a workflow. For example, the target application may display a visualization of well data and may include visualizations of types of geological material determined by the machine learning model.

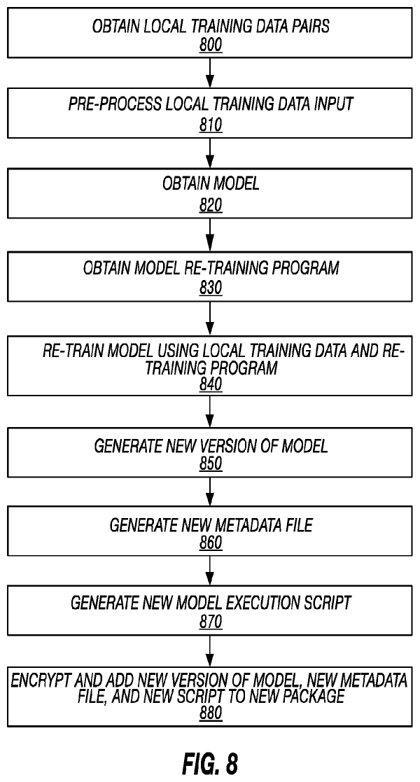

FIG. 8 illustrates an example of a method for re-training a machine learning model, according to an embodiment. The method shown in FIG. 8 is merely a simplified example. In further embodiments, model re-training methods can include additional or fewer processes, perform processes in different orders, perform two or more processes in parallel, etc.

In some embodiments, the example method illustrated in FIG. 8 can be performed using a computing device that includes the framework (e.g., framework 170) and the management components (e.g., management components 110) described above with reference to FIG. 1. In further embodiments, the example method illustrated in FIG. 8 can be performed on one or more client devices that can also run a target application. In still further embodiments, the example method can be performed using computing devices in a cloud computing environment or a distributed computing Hadoop cluster. In other embodiments, the example method illustrated in FIG. 8 can be performed using a data analytics wrapper that is associated with the target application (e.g., is a plug-in application of the target application) and/or using a re-training program.

The example method can begin in 800 when the computing device obtains local training data pairs to be used to train a machine learning model. In some embodiments, the local training data pairs can be obtained based on mappings of data from a database and/or from the target application to inputs of the model. In further embodiments, the local training data pairs and the mappings can be provided by and/or specified by a user.

In various embodiments, the local training data can be reservoir data such as, for example, seismic data, geophysical data, well data, models, visualizations, simulations, maps, images, videos, charts, graphs, etc. that correspond to one or more reservoirs.

In some embodiments, the local training data may include measured properties of a reservoir determined using, for example, core samples, seismic analysis, nuclear magnetic resonance, gamma ray logging, any other type of well logging, etc. Such properties can be collected using devices such as well-logging tools, logging-while-drilling devices, seismic receivers (e.g., geophones), imaging devices, etc. Measured properties can include, for example, rock type, porosity, permeability, pore volume, volumetric flow rates, well pressure, gas/oil ratio, composition of fluid in the reservoir, etc.

In further embodiments, the local training data can also include analysis data. The analysis data can represent the result of an analysis of the data by an interpreter, by a machine learning process, etc. For example, a well log can include analysis data from an interpreter that identifies types of geological material associated with the well log.

In 810, the computing device can pre-process the local training data input. In some embodiments, the pre-processing can include converting the local training data input into a format that can be read by the machine learning model. In various embodiments, the computing device can identify a pre-processing/conditioning program for pre-processing the data using metadata associated with the machine learning model, as described with regard to 640 in FIG. 6.

In 820, the computing device can obtain the model. For example, the computing device can obtain the encrypted model in a machine learning model package and decrypt the encrypted model, as described above.

In 830, the computing device can obtain a re-training program associated with the model. For example, the computing device can decrypt the re-training program from a machine learning model package.

In 840, the computing device can re-train the model using the local training data and the re-training program. In various embodiments, the computing device can re-train the model by inputting pre-processed input of an input/expected output pair in the local training data into the model, executing the model on the input, obtaining predicted output from the model, comparing the predicted output to expected output of the input/expected output pair, and determine whether the output is within a pre-determined distance of the expected output and/or whether the output is the same or similar to the expected output. In such an embodiment, parameters of the model can be updated if the output is not within the pre-determined distance and/or is not the same or similar to the expected output. For example, the parameters can be updated based on the distance between the output and the expected output. In some implementations, the computing device can perform the above process for each pair in the local training data pairs. In further implementations, other machine learning model training/re-training methods can be used (e.g., an unsupervised training method).

In 850, the computing device can generate a new version of the machine learning model. The new version of the machine learning model can be the same machine learning model algorithm with updated parameters based on the re-training in 840.

In 860, the computing device can generate a new version of the metadata file associated with the model. For example, the computing device can update a version number metadata entry in the metadata file based on the new version and/or update model path information in the metadata file based on a storage location of the new version of the machine learning model.

In 870, in some instances, the computing device can generate a new model execution script. For example, if the updated version of the model has a different path, different inputs, different input formats, different outputs, different identifiers, etc., the model execution script can be updated so that it can still execute the model.

In 880, the computing device can encrypt the new model file, the new metadata file, and the new model execution script using code compilation, obfuscation, signing, public/private key encryption, etc. The computing device can also generate a new machine learning model package by adding, compressing, and/or packaging, the encrypted model file, the encrypted metadata file, and the encrypted model execution script. For example, the model file, the metadata file, and the model execution script can be compressed into a single file.

Thus, a model can be re-trained based on local data or user-provided data to provide more accurate output for a local target application/user.

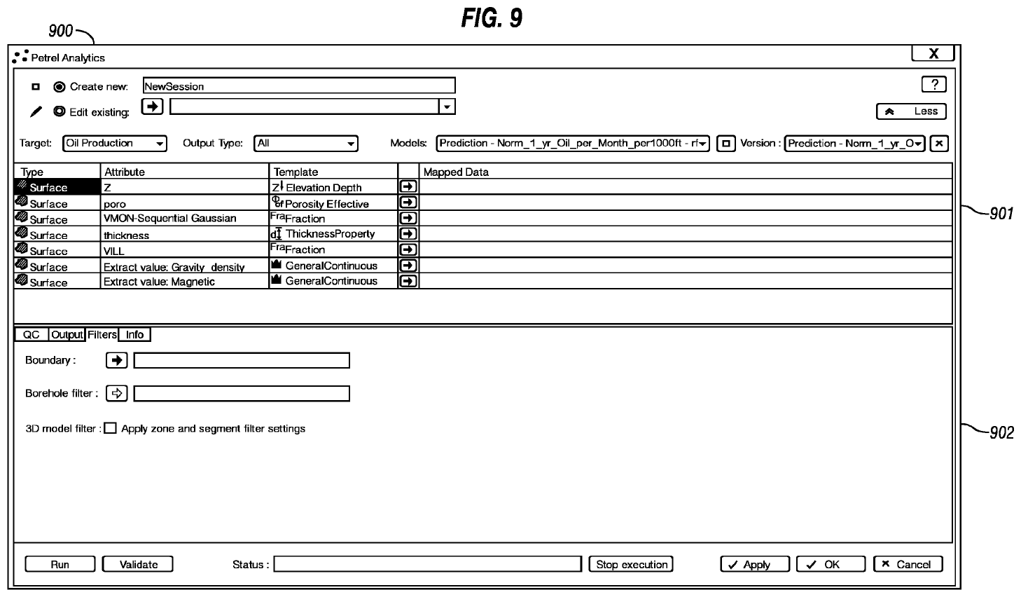

FIG. 9 illustrates a diagram of an example user interface that can be used for machine learning model execution and management, according to an embodiment. A user interface 900 can be provided by a target application, by a data analytics wrapper, and/or by a model execution script, as described above.

In various embodiments, the user interface 900 can allow a user to create a new data analytics session or edit an existing data analytics session for executing a machine learning model with data from a target application or other accessible data.

The user interface 900 can allow the user to select a target prediction process (e.g., oil production), select an output type, and select a machine learning model from among machine learning models that are deployed locally on a client device of the user and/or are remotely accessible to the user. The user interface 900 can also allow the user to select a specific version of the currently selected machine learning model.

The user interface 900 can also allow a user to run, validate, or stop execution of a model, and can display a current status of an execution of a model.

In a section 901, the user interface 900 can display inputs into the currently selected machine learning model. In some embodiments, the user interface 900 can display the types of the inputs, descriptions of the inputs, templates that correspond to the inputs, etc. In further embodiments, the user interface 900 can also allow a user to map data to the inputs. For example, the user can map data stored in a local or remote database to the inputs, the user can map data from processes of the target application to the inputs, etc.

In a section 902, the user interface 900 can allow a user to apply filters to the data that is input into the machine learning model. For example, the user interface 900 can allow the user to select a boundary filter, a borehole filter, a three-dimensional model filter, etc. to the data. As a further example, the user interface 900 can allow the user to apply zone and segment filter settings.

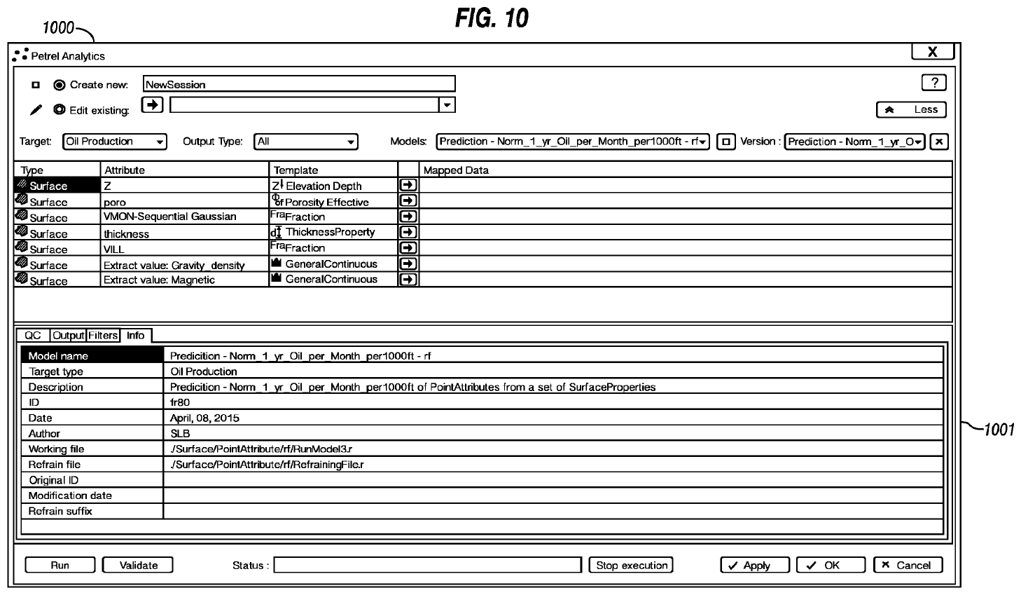

FIG. 10 illustrates a diagram of an example user interface that can be used for machine learning model execution and management, according to an embodiment. A user interface 1000 can be provided by a target application, by a data analytics wrapper, and/or by a model execution script, as described above.

In a section 1001, the user interface 1000 can allow a user to view metadata and/or other information of a machine learning model that is currently selected. For example, the user interface 1000 can identify and display metadata corresponding to: a model name, a target type, a description of a model, an identifier (“ID”) of a model, a date of creation of a model, an author of a model, a working file path of a model, a re-training program file path, an original ID of a model, a modification date of a model, and/or a re-training suffix of a model.

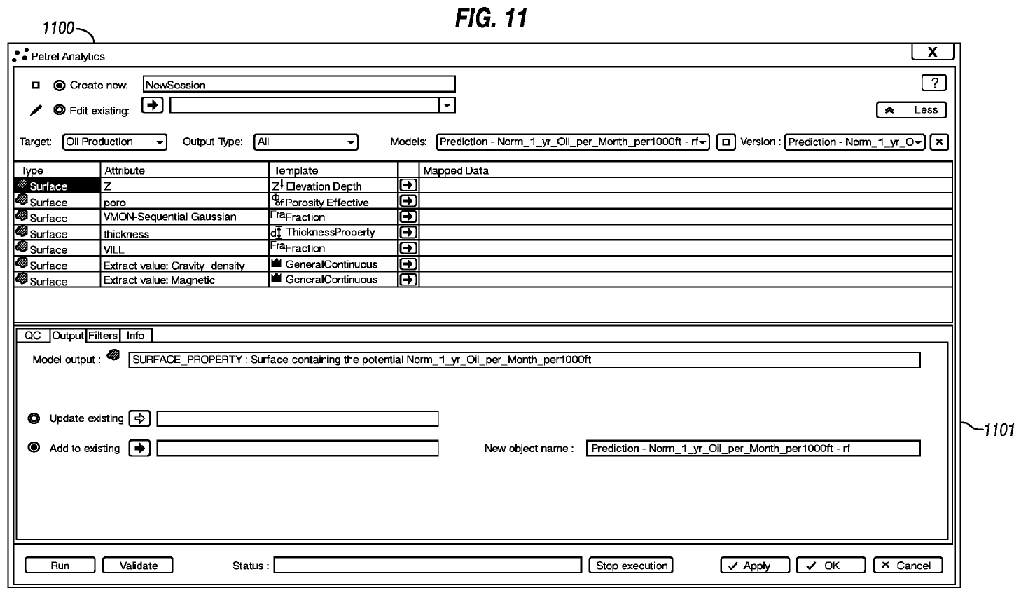

FIG. 11 illustrates a diagram of an example user interface that can be used for machine learning model execution and management, according to an embodiment. A user interface 1100 can be provided by a target application, by a data analytics wrapper, and/or by a model execution script, as described above.

In a section 1101, the user interface 1100 can allow a user to choose to map the model output to an existing or new object associated with a target application.

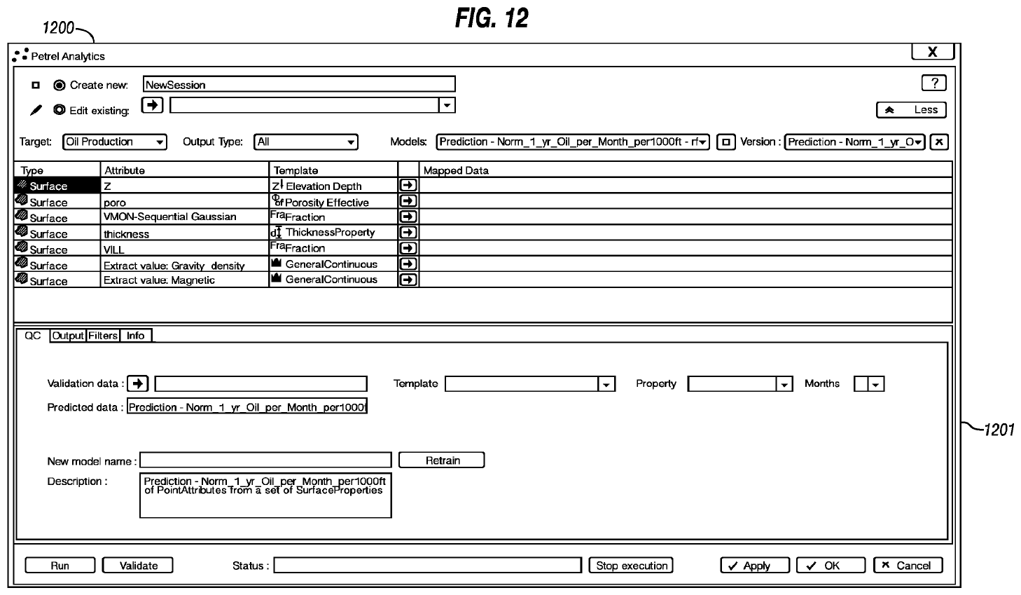

FIG. 12 illustrates a diagram of an example user interface that can be used for machine learning model execution and management, according to an embodiment. A user interface 1200 can be provided by a target application, by a data analytics wrapper, and/or by a model execution script, as described above.

In a section 1201, the user interface 1200 can allow a user to specify the name of the predicted output object from the model and also select known output data that can be used to validate the model. The user interface 1200 can also allow the user to re-train the currently selected model, and enter a name and description of the re-trained model.

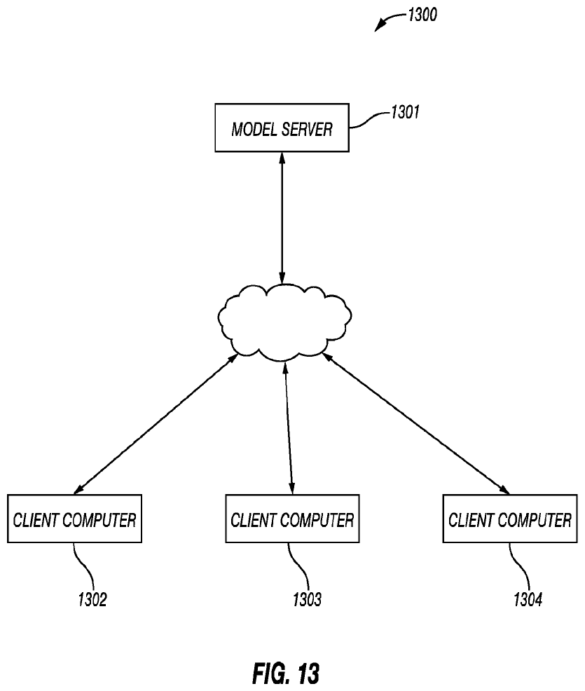

FIG. 13 illustrates an example of a model package generation, management, and deployment system, according to an embodiment. As depicted in FIG. 13, the model package generation, management, and deployment system can include a model server 1301. In additional embodiments, model package generation, management, and deployment system can include multiple model servers. As further depicted in FIG. 13, the model package generation, management, and deployment system can include three client computers 1302, 1303, and 1304. In additional embodiments, a model package generation, management, and deployment system can include fewer or more client computers.

Model server 1301 can be connected to client computers 1302, 1303, and 1304 via a network 1309 that includes, for example, the internet. Model server 1301 can be, for example, one or more high performance computing devices that provide large amounts of distributed storage, memory, and processing resources (compared to client computers) to train machine learning models, generate and encrypt model files, model execution scripts, and metadata files, and generate machine leaning model packages. For example, model server 1301 can represent computing devices in a cloud computing environment or a distributed computing Hadoop cluster.

In some embodiments, model server 1301 can also store and make available the generated machine learning model packages. Further, in some implementations, model server 1301 can continuously or periodically update machine learning models to generate new versions of machine learning models based on additional training data.

The machine learning model packages can be deployed and distributed to client computers 1302, 1303, and 1304, using, for example, a target application and/or data analytics wrapper running on the client computers 1302, 1303, and 1304. Additionally, model server 1301 can provide model management services to client computers 1302, 1303, and 1304, such as scoring the machine learning models, providing new versions of the machine learning models, etc.

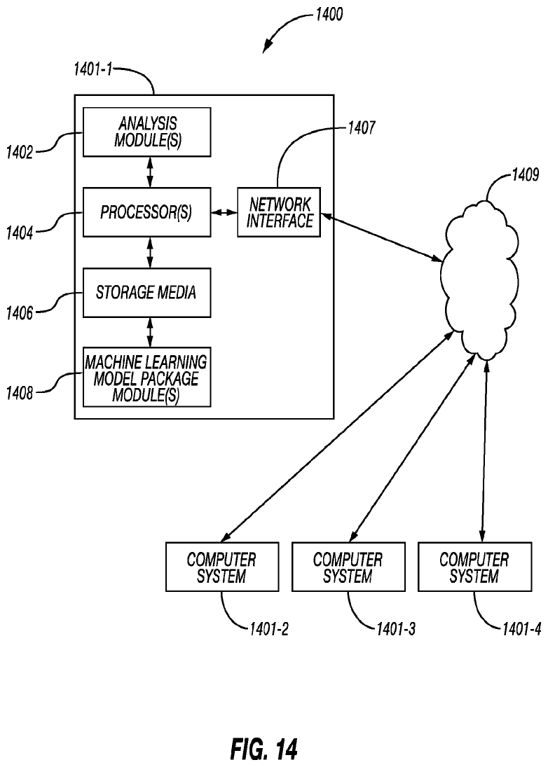

In some embodiments, the methods of the present disclosure may be executed by a computing system. FIG. 14 illustrates an example of such a computing system 1400, in accordance with some embodiments. The computing system 1400 may include a computer or computer system 1401-1, which may be an individual computer system 1401-1 or an arrangement of distributed computer systems. The computer system 1401-1 includes one or more analysis modules 1402 that are configured to perform various tasks according to some embodiments, such as one or more methods disclosed herein. To perform these various tasks, the analysis module 1402 executes independently, or in coordination with, one or more processors 1404, which is (or are) connected to one or more storage media 1406. The processor(s) 1404 is (or are) also connected to a network interface 1407 to allow the computer system 1401-1 to communicate over a data network 1409 with one or more additional computer systems and/or computing systems, such as 1401-2, 1401-3, and/or 1401-4 (note that computer systems 1401-2, 1401-3, and/or 1401-4 may or may not share the same architecture as computer system 1401-1, and may be located in different physical locations, e.g., computer systems 1401-1 and 1401-2 may be located in a processing facility, while in communication with one or more computer systems such as 1401-3 and/or 1401-4 that are located in one or more data centers, and/or located in varying countries on different continents).

A processor may include a microprocessor, microcontroller, processor module or subsystem, programmable integrated circuit, programmable gate array, or another control or computing device.

The storage media 1406 may be implemented as one or more computer-readable or machine-readable storage media. Note that while in the example embodiment of FIG. 14 storage media 1406 is depicted as within computer system 1401-1, in some embodiments, storage media 1401-1 may be distributed within and/or across multiple internal and/or external enclosures of computing system 1401-1 and/or additional computing systems. Storage media 1406 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 1400 contains machine learning model package module(s) 1408 for training machine learning models, generating and encrypting model files, model execution scripts, and metadata files, generating machine leaning model packages, obtaining machine learning models, decrypting files, preparing data for inputting into models, invoking model execution scripts to execute models, providing outputs of the models to a UI and/or a target application, building and training new models, re-training existing models, etc. In the example of computing system 1400, computer system 1401-1 includes the machine learning model package module 1408. In some embodiments, a machine learning model package module may be used to perform aspects of one or more embodiments of the methods disclosed herein. In alternate embodiments, a plurality of machine learning model package modules may be used to perform aspects of methods disclosed herein.

It should be appreciated that computing system 1400 is one example of a computing system, and that computing system 1400 may have more or fewer components than shown, may combine additional components not depicted in the example embodiment of FIG. 14, and/or computing system 1400 may have a different configuration or arrangement of the components depicted in FIG. 14. The various components shown in FIG. 14 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of protection of the disclosure.

Geologic interpretations, models, and/or other interpretation aids may be refined in an iterative fashion; this concept is applicable to the methods discussed herein. This may include use of feedback loops executed on an algorithmic basis, such as at a computing device (e.g., computing system 1400, FIG. 14), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limited to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to explain principals of the disclosure and practical applications, to thereby enable others skilled in the art to utilize the disclosure and various embodiments with various modifications as are suited to the particular use contemplated.

What is claimed is:

1. A method, comprising:
training a machine learning model;
obtaining metadata corresponding to the machine learning model;
generating a model execution script for executing the machine learning model;
obtaining a re-training program associated with the machine leaning model, wherein the re-training program can be used to re-train the machine learning model in a run-time environment of a target application; and
generating a machine learning model package comprising the machine learning model, the metadata, the model execution script, and the re-training program.

2. The method of claim 1, further comprising encrypting a machine learning model file corresponding to the machine learning model, wherein the machine learning model in the machine learning model package is an encrypted version of the machine learning model file.

3. The method of claim 1, further comprising encrypting a metadata file that comprises the metadata corresponding to the machine learning model, wherein the metadata in the machine learning model package is an encrypted version of the metadata file.

4. The method of claim 3, wherein the metadata file corresponds to a JavaScript Object Notation (JSON) schema.

5. The method of claim 1, further comprising encrypting the model execution script, wherein the model execution script in the machine learning model package is an encrypted version of the model execution script.

6. The method of claim 1, further comprising transmitting the machine learning model package to a client computer that can invoke the target application, wherein the client computer:
obtains the machine learning model, the metadata, and the model execution script from the machine learning model package;
identifies inputs of the machine leaning model based on the metadata;
obtains input data; and
executes the machine leaning model using the model execution script and the input data to analyze the input data.

7. The method of claim 6, wherein the model execution script:
obtains input from the target application or a data analytics wrapper;
conditions the input into a format that can be used by the machine learning model;
inputs the input into the machine learning model;
obtains output from the machine learning model;
renders the output into a format that can be read by the data analytics wrapper or the target application; and
transmits the output to the data analytics wrapper or the target application.

8. The method of claim 6, wherein obtaining the machine learning model, the metadata, and the model execution script comprises decrypting an encrypted machine learning model file, an encrypted metadata file, and an encrypted model execution script from the machine learning model package.

9. The method of claim 6, wherein the client computer maps the inputs of the machine learning model with the input data based on the metadata

10. The method of claim 1, wherein the metadata comprises one or more of:
a model identifier;
a model name;
a model description;
a model type;
a machine learning algorithm type;
a model version;
a model input;
a model output;
a model input type;
a model output type;
a pre-processing/conditioning program name;
a post-processing program name;
a time of model creation;
a model execution script identifier;
a re-training program name;
a model author; or
a modification time.

11. The method of claim 1, wherein the model execution script includes a user interface that is configured based on the metadata.

12. The method of claim 1, further comprising encrypting the re-training program, wherein the re-training program in the machine learning model package is an encrypted version of the re-training program.

13. The method of claim 1, wherein the target application comprises an exploration and production sector software system.

14. A computing system comprising:
one or more processors; and
a memory system comprising one or more non-transitory, computer-readable media storing instructions that, when executed by at least one of the one or more processors, cause the computing system to perform operations, the operations comprising:
training a machine learning model;
obtaining metadata corresponding to the machine learning model;
generating a model execution script for executing the machine learning model;
obtaining a re-training program associated with the machine leaning model, wherein the re-training program can be used to re-train the machine learning model in a run-time environment of a target application; and
generating a machine learning model package comprising the machine learning model, the metadata, the model execution script, and the re-training program.

15. The system of claim 14, the operations further comprising encrypting a machine learning model file corresponding to the machine learning model, wherein the machine learning model in the machine learning model package is an encrypted version of the machine learning model file.

16. The system of claim 14, the operations further comprising transmitting the machine learning model package to a client computer that can invoke the target application, wherein the client computer:
obtains the machine learning model, the metadata, and the model execution script from the machine learning model package;
identifies inputs of the machine leaning model based on the metadata;
obtains input data; and
executes the machine leaning model using the model execution script and the input data to analyze the input data.

17. The system of claim 16, wherein the model execution script:
obtains input from the target application or a data analytics wrapper;
conditions the input into a format that can be used by the machine learning model;
inputs the input into the machine learning model;
obtains output from the machine learning model;
renders the output into a format that can be read by the data analytics wrapper or the target application; and
transmits the output to the data analytics wrapper or the target application.

18. A non-transitory, computer-readable medium storing instructions that, when executed by one or more processors of a computing system, cause the computing system to perform operations, the operations comprising:
training a machine learning model;
obtaining metadata corresponding to the machine learning model;
generating a model execution script for executing the machine learning model;
obtaining a re-training program associated with the machine leaning model, wherein the re-training program can be used to re-train the machine learning model in a run-time environment of a target application; and
generating a machine learning model package comprising the machine learning model, the metadata, the model execution script, and the re-training program.

19. The medium of claim 18, the operations further comprising transmitting the machine learning model package to a client computer that can invoke the target application, wherein the client computer:
obtains the machine learning model, the metadata, and the model execution script from the machine learning model package;
identifies inputs of the machine leaning model based on the metadata;
obtains input data; and
executes the machine leaning model using the model execution script and the input data to analyze the input data.

20. The medium of claim 19, wherein the model execution script:
obtains input from the target application or a data analytics wrapper;
conditions the input into a format that can be used by the machine learning model;
inputs the input into the machine learning model;
obtains output from the machine learning model;
renders the output into a format that can be read by the data analytics wrapper or the target application; and
transmits the output to the data analytics wrapper or the target application.
